(19) United States
(12) Patent Application Publication
(10) Pub. No.: US 2002/0033759 A1
(43) Pub. Date: Mar. 21, 2002

(54) Water leak detection and suppression

(75) Inventor: Richard L. Morello, Naples, FL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Linjan Corp., Inc., Naples, FL (US)

(21) Appl. No.: 09/792,027

(22) Filed: Feb. 26, 2001

Related U.S. Application Data
(60) Provisional application No. 60/184,883, filed on Feb. 25, 2000.
(60) Provisional application No. 60/230,028, filed on Sep. 5, 2000.

(30) Foreign Application Priority Data
Feb. 23, 2001 (US) 201996US99

(51) Int. Cl. G08B 21/00

(52) U.S. Cl. 340/605; 340/539

(57) ABSTRACT

A system and a method for the detection of a water leak. An alarm can be sounded and a valve closed to shut off a water supply when a wireless sensor is in the presence of water. Exemplary embodiments of the wireless sensor can be battery supplied and mounted to a wall or a floor. In fact, a magnetic latching valve can be used to minimize power consumption, and allow the entire system to be battery supplied as needed. Wireless sensors according to the present invention can be disposed in homes or commercial buildings, including, e.g., under hot water tanks, sinks, A/C drip pans, ice makers, washer machines, and/or toilets.

### CROSS-REFERENCE TO RELATED APPLICATIONS

This application claims the benefit of U.S. Provisional Application Nos. 60/184,883 filed Feb. 25, 2000 and 60/230,028 filed Sep. 5, 2000.

### BACKGROUND OF THE INVENTION

1. Field of the Invention

This invention is directed towards the detection and suppression of leaking water. More specifically, this invention is directed to providing a system and a method for the detection and suppression of leaking water that is easy to install and operate in an existing house and/or other structure.

2. Discussion of the Background

Indoor plumbing is responsible for both saving the lives of many thousands and improving the standard of living of many millions of individuals each year. Improved sanitation, increased convenience, and the savings of many millions of hours of labor result from the transport of water and sewage (hereinafter water) by pipes and other structures that are located inside sheltering structures such as homes.

However, a fundamental conflict exists between the sheltering structure, which is designed to isolate the inhabitants from elements like water, and the water carried by plumbing inside the sheltering structure, since water can damage either the shelter or the human occupiers of the shelter. With modem developments in piping and piping techniques, the vast majority of damage to either shelters or the human occupiers of shelters is due to relatively infrequent and small volume water leaks.

Given the benefits and relative robustness of modem indoor plumbing, most of humanity chooses to tolerate these relatively small and rare water leaks and the resultant damage to structures and human health. However, several others have attempted to develop systems that will provide the owner/operator of a sheltering structure with notification and the automatic suppression of water leaks.

For example, U.S. Pat. No. 4,845,472 to Gordon et al., the contents of which are incorporated herein by reference, describes a leak sensing alarm and supply shut-off apparatus. Both the control console or box of the leak sensing alarm and the supply shut-off operate on the available house current (supply line 58). Moreover, although the majority of the control circuit is located within the control console or box, both the water detector and the solenoid shut-off valve are integral parts of the control circuit (col. 4, line 8-9 and col. 4, line 25-27). Thus, the control console or box must be connected by wires 54 to the water detector and to the solenoid shut-off valve.

Since a wired connection must exist between the detector element and the control console or box, the apparatus of Gordon et al. requires an initial capital investment that includes fitting (or retrofitting) a structure with extensive cabling. As described above, with modem piping and piping techniques, water leaks are relatively rare, and many people chose to tolerate the damage caused by water leaks rather than undertaking this Herculean task. Finally, since the apparatus of Gordon et al. also requires a line power supply feed, still further cabling is required and the apparatus will not operate in the event of a power interruption.

Further examples of water leak detectors include the following.

U.S. Pat. No. 4,924,174 to Sheahan, the contents of which are incorporated herein by reference, describes a hold-down device for multi-layered roofs. The hold-down device can be modified to afford a water leak detector.

U.S. Pat. No. 5,517,174 to Barrows, the contents of which are incorporated herein by reference, describes a sensor that includes a hollow tube that has a first and a second end. A cap is secured at the first end, and the second end is open to allow fluid to enter the tube. Inside the tube a flotation element is slidably arranged. Furthermore, a contact switch is arranged within the tube between the cap and the flotation element and used to determine the position of the flotation element relative to the cap.

U.S. Pat. No. 5,522,229 to Stuchlik, et al., the contents of which are incorporated herein by reference, describes a liquid sensor probe located at least partially in a drain tube. The liquid sensor probe detects the undesired accumulation of liquid in the drain tube caused by, for example, a blockage.

U.S. Pat. No. 4,888,455 to Hanson, the contents of which are incorporated herein by reference, describes a pair of electrical contacts that are separated by a material which becomes frangible when moistened. When this frangible material becomes moist it breaks and the pair of electrical contacts close. This is used as a water detection mechanism.

U.S. Pat. No. 5,781,117 to Rish, the contents of which are incorporated herein by reference, describes a portable water level detector or flood alarm device that is adapted to be permanently or removably secured to any surface or terrain at any angular position.

U.S. Pat. No. 4,754,399 to Kimura, the contents of which are incorporated herein by reference, describes a device for generating an alarm signal in the event of an environmental abnormality. This device includes a plurality of sensors that detect the level of an environmental abnormality and converts the detected level using coefficients proportional to sensing volumes in order to determine an error state.

U.S. Pat. No. 4,630,038 to Jordan, the contents of which are incorporated herein by reference, describes a method and a device for continuously analyzing, retaining, and periodically displaying the concentration of a selected component and an emission gas from a vapor recovery unit.

U.S. Pat. No. 4,488,567 to Grant, the contents of which are incorporated herein by reference, describes a valve closure device that includes a low revolution per minute motor with a shaft coupled to the stem of a shut-off valve located in the supply line of a water heater or similar device.

U.S. Pat. No. 4,374,379 to Dennison, Jr., the contents of which are incorporated herein by reference, describes a moisture sensing device. In this moisture sensing device, an alarm actuating circuit that includes a pair of closely space electrical conductors is connected with an alarm actuating circuit.

U.S. Pat. No. 4,246,575 to Purtell et al., the contents of which are incorporated herein by reference, describes a compressed, dehydrated cellulose sponge wafer that is positioned between conductive plates. A bridging conductor electrically connects the two plates together upon swelling of the wafer when the wafer is placed into contact with moisture. Since the wafer expands upon contact with moisture, the two plates are forced into contact. This indicates the presence of water at the cellulose sponge wafer.

U.S. Pat. No. 4,805,662 to Moody, the contents of which are incorporated herein by reference, describes a hot water heater failure protection device. In this device, a ground fault interrupter (GFI) circuit is wired to a main circuit breaker panel. Furthermore, a solenoid valve controls the supply of cold water to a conventional hot water heater. The solenoid valve is held in an open position by 110 VAC and is closed when current is cut off. The other output of the GFI circuit provides 110 VAC to a leak detector.

U.S. Pat. No. 4,677,371 to Imaizumi, the contents of which are incorporated herein by reference, describes a sensor for detecting the presence and location of a water leak. In the sensor, a coaxial cable and a bare wire are aligned in parallel relationship and fixed within insulation covers that have openings. When moisture bridges the distance between the coaxial cable and the bare wire, a resistance meter can be used to detect the presence of water.

U.S. Pat. No. 4,166,244 to Woods et al., the contents of which are incorporated herein by reference, describes a leakage detection system for radioactive waste storage tanks.

### SUMMARY OF THE INVENTION

Accordingly, one object of this invention is to provide a novel system and a method for the detection and suppression of leaking water.

Another object of this invention is to provide a novel system and a method for the detection and suppression of leaking water that, in some embodiments, does not require fitting (or retrofitting) a structure with extensive cabling.

Another object of this invention is to provide a novel system and a method for the detection and suppression of leaking water that, in some embodiments, does not require connection to a supply line.

These and other objects of the invention are realized by providing a novel system for the detection and suppression of leaking water that includes a valve configured to open or close a pipe upon receipt of a valve signal; a controller configured to receive notification indicative of a water leak and to transmit the valve signal to the valve; and a wireless moisture detector configured to determine the presence of water indicative of the water leak and to transmit the notification indicative of a water leak in response to this presence, where the wireless moisture detector including a transmission means for wirelessly transmitting the notification indicative of the water leak and the controller including means for wirelessly receiving the notification indicative of the water leak.

A method according to the present invention for detecting and suppressing a water leak includes transducing the presence of water in the neighborhood of a wireless sensor; transmitting wirelessly a moisture detection signal from the wireless sensor indicative of the presence of water; and closing a valve in response to receipt of the moisture detection signal.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a schematic diagram of an illustrative embodiment of a leak detector system according to the present invention;

FIG. 2 is a schematic diagram of a second illustrative embodiment of a leak detector system according to the present invention;

FIG. 3 is a schematic diagram of an exemplary wireless sensor in accordance with the present invention;

FIG. 4 is a schematic diagram of an exemplary system control in accordance with the present invention; and

FIG. 5 is a circuit diagram of an exemplary embodiment of a leak detector system according to the present invention.

### DETAILED DESCRIPTION OF THE PREFERRED EMBODIMENTS

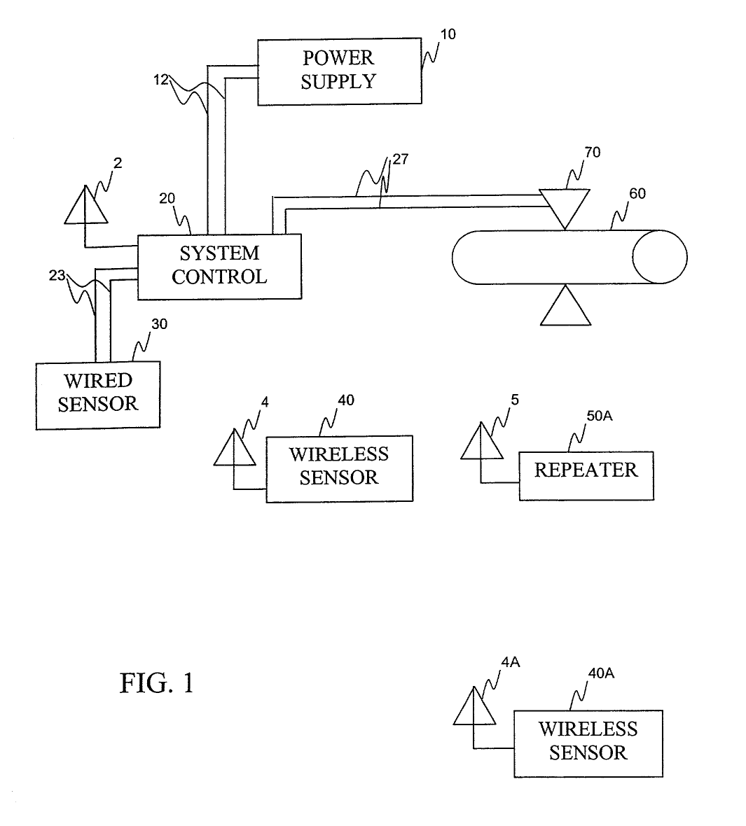

Referring now to the drawings, wherein like reference numerals designate identical or corresponding parts throughout the several views, and more particularly to FIG. 1 thereof, which provides a schematic diagram of an illustrative embodiment of a leak detector system according to the present invention. The illustrated embodiment of FIG. 1 includes three different dispositions of moisture detectors, namely wired sensor 30 and wireless sensors 40 and 40A. Wired sensor 30 is in communication with system control 20 by way of leads 23 and 40A. However, both wireless sensors 40 and 40A communicate with system control 20 by way of a wireless connection using the respective of antennae 2, 4, and 4A. As illustrated in the exemplary embodiment shown in FIG. 1, a remote moisture detector can communicate with system control 20 by way of a relay 50 that includes its own receiving and transmitting antenna 5. Moreover, each of the wireless sensors 40 and 40A and relay 50 can be powered by an internally housed battery (not shown).

Once a moisture detection signal is communicated from one or more of the moisture detectors 30, 40, and/or 40A to the control system 20, the control system relays a valve close signal to one or more magnetic latch valves 70, which in turn acts to close one or more pipes 60. In alternate embodiments, other magnetic latch valves 70 will be distributed throughout the pipe network of the structure, and a germane valve will be selected for closure in response to the location of the moisture detector 30, 40, and/or 40A that transmits to the moisture detection signal.

Since one or more magnetic latch valves 70 is used to close one or more pipes 60, the power consumption of the system is quite low. Indeed, magnetic latch valve(s) 70 remain open or closed without power consumption. In other words, only two leads 27 are needed to carry a switching signal to a magnetic latch valve 70, and no other feed line is needed. As such, the power supply 10, which powers the system control, can be formed from only a battery. As such, power supply 10 can be internal to the system control 20 and leads 12 eliminated. Suitable exemplary supplies that are capable of forming power supply 10 include one or more 12 VDC batteries.

A power supply 10 that includes both a line feed and a battery back-up is advantageous in that it provides for long term operation that will remain uninterrupted in the event of a power outage.

The use of a portable, low power supply in combination with wireless sensors allows the system control to be placed immediately adjacent to the magnetic latch valve 70. As such, the length of leads 27 can be minimized, and the amount of fitting (and/or retrofitting), such as additional cabling, needed to implement the present invention is minimal. As such, installation costs and time are significantly reduced. Moreover, the present system will continue to operate even in the event of a power outage, such as, e.g., in the event of a blizzard where pipes are also prone to freeze.

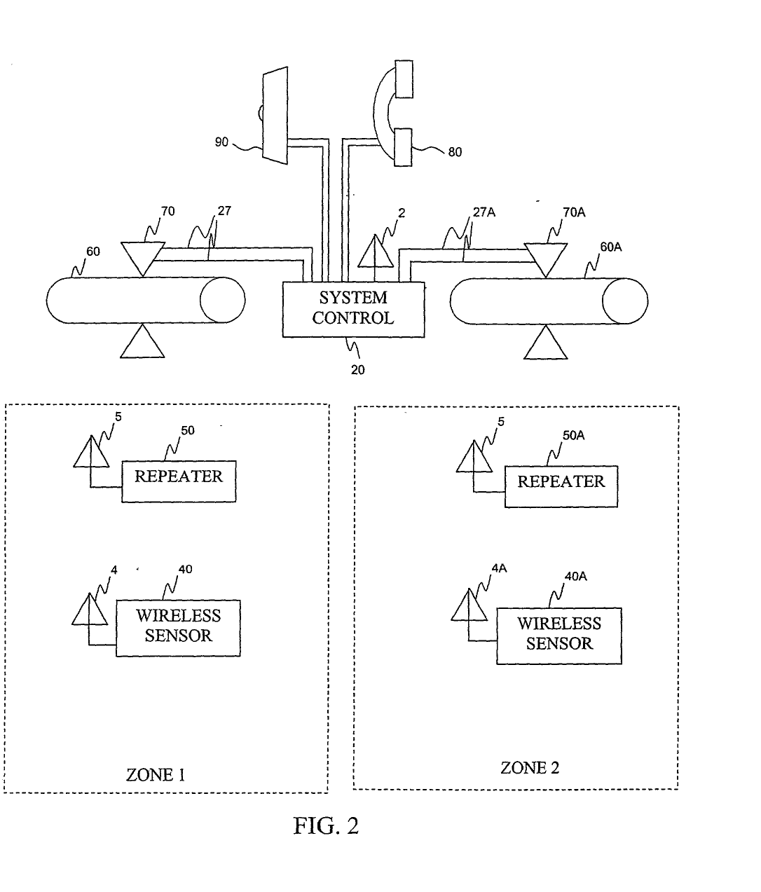

FIG. 2 presents a schematic diagram of a second illustrative embodiment of a leak detector system according to the present invention. The leak detector system of FIG. 2 is adapted to operate in larger shelters (e.g., commercial buildings) where the unspecific notification of a non-localized leak somewhere in the shelter must be followed by localization of the leak and suppression of the leak while maintaining water supply to the remainder of the shelter, if possible.

Thus, in order to assist in localizing the leak, the shelter is divided into a series of virtual zones, each containing one or more moisture detectors. The exemplary ZONE 1 and ZONE 2 shown in FIG. 2 each includes a single wireless sensor 40 or 40A and a single repeater 50 and 50A, although other moisture detectors such as wired sensor 30 can be used and/or a repeater omitted. Regardless of the type and/or number of moisture detectors or repeaters used, each moisture detector communicates with the system control 20, and can be recognized by system control 20 as belonging to a particular zone. This can be done, e.g., by providing each moisture detector with a unique identifier (ID number) that is communicated to the system control along with moisture detection signal(s).

Once the system control 20 receives the moisture detection signal(s) along with the information that identifies the transmitting moisture detector as belonging to a particular zone, then the system control can transmit a valve close signal to the relevant magnetic latch valve 70 and/or 70A, thereby closing pipe 60 and/or 60A and preventing the transport of further amounts of water into the particular zone. As illustrated in FIG. 2, wires 27 and 27A connect the system control 20 with both of the magnetic latch valves 70 and/or 70A. This is not necessarily the case, and a wireless connection can also be used to transmit, e.g., valve close signals and valve open s.

Also illustrated in FIG. 2 are various further means of obtaining status update information from the system control 20. For example, system control 20 can transmit a fault to alarm 90, thereby informing the owner/operator of a sheltering structure with notification of a fault. As another example, system control 20 can communicate through a communication interface 80 with a communication network such as a telephone network, so that the owner/operator of a sheltering structure can remotely monitor and control the operation of the leak detector system according to the present invention.

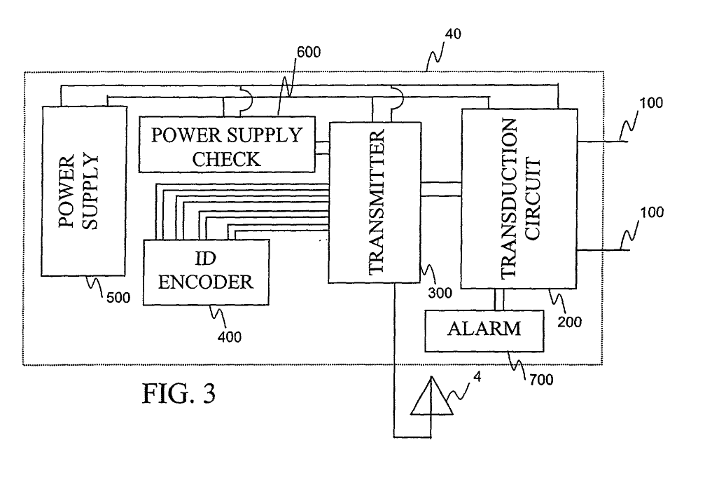

FIG. 3 schematically illustrates an exemplary wireless sensor 40 in accordance with the present invention. The wireless sensor 40 includes a pair of conducting probes 100 that are not ideally polarizable in water. In other words, if the two probes 100 are transferred from dry air to water, a significant drop in the resistance between the two probes occurs. Exemplary materials that can form the probes 100 include metals such as stainless steels, conducting polymers like polythiophene, and conducting carbonic materials like graphite and wax-impregnated graphite.

Transduction circuit 200 identifies the drop in resistance between the probes 100 in the presence of water. As used herein, the presence of water usually indicates greater than 100% relative humidity (i.e., the presence of standing water). However, the standing water need not necessarily saturate the electrical path between the probes 100, but rather be present in a quantity that is sufficient to impregnate a porous material like a wood, a sponge, and/or a porous ceramic and form a conductive path.

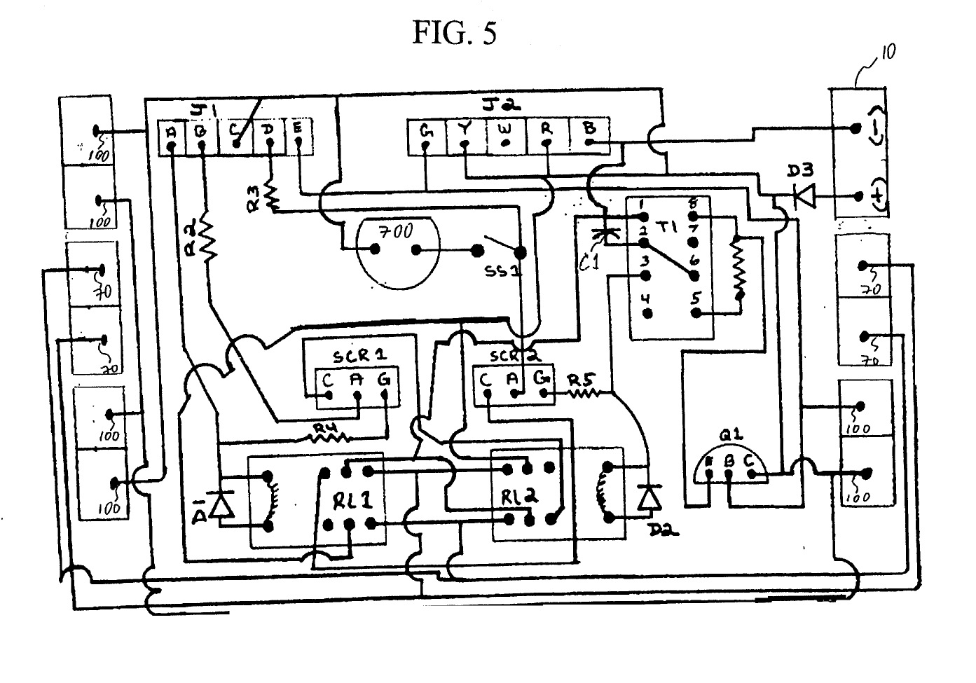

Various types of transduction circuits are known in the art. An example of one such circuit is shown in FIG. 5, wherein a circuit diagram of a transduction valve according to the present invention is shown.

The transmitter 300 of wireless sensor 40 receives a moisture detection from the transduction circuit 200 and transmits it, after processing, using antenna 4. Transmitter 300 can be formed from any wireless transmitter such as, e.g., AM or FM radio wave transmitters, infrared data transmitters, Ultra Wide Band transmitters, or even acoustic or light transmitters. It is only necessary that transmitter 300 be able to communicate a moisture detection, along with an ID number and/or a low supply as needed, to either a repeater 50 or a system control 20.

ID encoder 400 encodes identification information that can be relayed by the transmitter 300 to a system control 20 and used to identify and/or localize the wireless sensor 40. This identification information can be either a unique ID number that specifically identifies the wireless sensor 40, or it can be a zone ID number that identifies the zone where the wireless sensor 40 is located. An exemplary ID encoder is a DIP switch.

Power supply 500 provides power to the transduction circuit 200 and the transmitter 300 for the above-described operations. Since the transduction circuit 200 can be configured to only draw significant amounts of power when the resistance between the probes 100 drops, and transmitter 300 can be configured to only transmit when a moisture detection signal is received from the transduction circuit 200, the power requirements of such a wireless sensors 40 are quite small and power supply 500 can be formed by, e.g., a battery.

The power level of power supply 500 can be constantly monitored by a power supply check 600, which determines, e.g., when the voltage output by power supply 500 drops below a predetermined level. When this happens, a low supply signal is relayed to the transmitter 300, which in turn processes it and transmits it using antenna 4 to either a repeater 50 or a system control 20.

Furthermore, the exemplary wireless sensor 40 illustrated in FIG. 3 has a buzzer alarm 700 built into its casing. The buzzer alarm 700 can be triggered by a moisture detection signal from the transduction circuit 200 and/or a low supply signal from the power supply check 600 (not shown), and will aid during manual location of the exemplary wireless sensor 40 during a water leak or in case of a low power power supply 500.

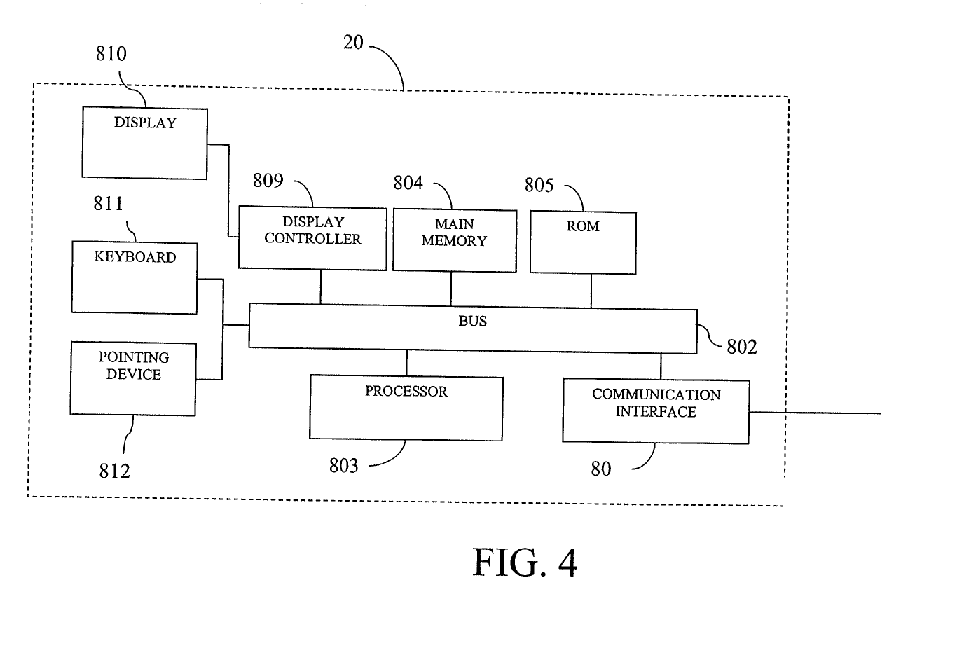

FIG. 4 is a schematic diagram of an exemplary system control 20 in accordance with the present invention. System control 20 includes a bus 802 or other communication mechanism for communicating information, and a processor 803 coupled with bus 802 for processing the information. Processor 803 can be formed by logic circuits, a microprocessor, special purpose logic devices (e.g., application specific integrated circuits (ASICs)) or configurable logic devices (e.g., generic array of logic (GAL) or reprogrammable field programmable gate arrays (FPGAs)). System control 20 can also include a main memory 804, such as a random access memory (RAM) or other dynamic storage device (e.g., dynamic RAM (DRAM), static RAM (SRAM), synchronous DRAM (SDRAM), flash RAM), coupled to bus 802 for storing information and instructions to be executed by processor 803. In addition, main memory 804 may be used for storing temporary variables or other intermediate information during execution of instructions to be executed by processor 803. System control 20 can further include a read only memory (ROM) 805 or other static storage device (e.g., programmable ROM (PROM), erasable PROM (EPROM), and electrically erasable PROM (EEPROM)) coupled to bus 802 for storing static information and instructions for processor 803.

Other removable media devices (not shown) (e.g., a compact disc, a tape, and a removable magneto-optical media) or fixed, high density media drives, may be added to the system control 20 using an appropriate device bus (e.g., a small computer system interface (SCSI) bus, an enhanced integrated device electronics (IDE) bus, or an ultra-direct memory access (DMA) bus).

System control 20 may be coupled via bus 802 to a display 810, such as a cathode ray tube (CRT) and/or a series of LEDs, for displaying information to a owner/operator of a shelter. Display 810 can include an alarm 90 as shown in FIG. 2, especially when the confirmation is a yes/no indication that moisture has been detected. Display 810 can also include an LED display that shows if one or more magnetic latching valves is open or closed. The display 810 may be controlled by a display or graphics card 809 as needed. The system control 20 can also include input devices, such as one or more rocker switches (not shown) that allows an owner/operator of the shelter to reopen or close one or more magnetic latching valves 70, a keyboard 811, and/or a pointing device 812 (e.g., a cursor control), for communicating information and command selections to processor 803. The pointing device 812 (e.g., cursor control), for example, is a mouse, a trackball, or cursor direction keys for communicating direction information and command selections to processor 803 and for controlling cursor movement on the display 810. In addition, a printer (not shown) may provide a hardcopy record of moisture detection history and responses.

System control 20 may also perform a portion or all of the processing steps of the invention in response to processor 803 executing one or more sequences of one or more instructions contained in memory 805. Such instructions may be read into memory 805 from another computer readable medium. One or more processors in a multi-processing arrangement may also be employed to execute the sequences of instructions. As stated above, in alternative embodiments, hard-wired circuitry may be used in place of or in combination with software instructions. Thus, embodiments are not limited to any specific combination of hardware circuitry and software.

As stated above, the system control 20 can include at least one computer readable medium or memory programmed according to the teachings of the invention and for storing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the system control 20, for opening and closing one or more magnetic latch valves 70, and for enabling the system control 20 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium or media that participate in providing instructions to processor 803 for execution. A computer readable medium may take many forms, including but not limited to, non-volatile media, volatile media, and transmission media. Transmission media includes coaxial cables, copper wire and fiber optics, including the wires that comprise bus 802. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to system control 20 may receive the data on the telephone line and use an infrared transmitter to convert the data to an infrared signal. An infrared detector coupled to bus 802 can receive the data carried in the infrared signal and place the data on bus 802. Bus 802 carries the data to memory 808, from which processor 803 retrieves and executes the instructions. The instructions received by memory 808 may optionally be stored on a removable media storage device either before or after execution by processor 803.

System control 20 may also include a communication interface 80 coupled to bus 802. Communication interface 80 can provide two-way data communication through a network. For example, communication interface 80 may be a network interface card to attach to any packet switched local area network (LAN). As another example, communication interface 80 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 80 sends and receives electrical, electromagnetic or optical signals that carry digital data streams representing various types of information.

The communications network typically provides data communication through one or more networks to other data devices. For example, a communications network may provide a connection to a computer (not shown) through a local network (e.g., a LAN) or through equipment operated by a service provider, which provides communication services through a communications network. In some embodiments, the communications network uses electrical, electromagnetic, or optical signals that carry digital data streams. The signals through the various network communication interface 80, which carry the digital data to and from system control 20, are exemplary forms of carrier waves transporting the information. System control 20 would thus be able to transmit notifications and receive data, including status update information, through the network(s) and communication interface 80.

FIG. 5 is a circuit diagram of an exemplary embodiment of a leak detector system according to the present invention. All of the connections in FIG. 5 are shown as wire connections, although, as described above, this is not necessarily the case. Thus, in the circuit diagram shown in FIG. 5, each of the wires simply indicates communication, be it wired or wireless, between two points.

The exemplary leak detector system in FIG. 5 is powered by a supply 10 that supplies the system through the, e.g., DC power terminals (+) and (−). Correct polarity of the supply is ensured by diode D3. Transduction can be performed using a transistor Q1, which can be formed by, e.g., a PN1111A NPN transistor. In this case, the supply power positively biases both the collector C of transistor Q1 and one or more of the probes 100. When a conductive path is formed between a positively biased probe 100 and the neighboring probe 100, then the base B of transistor Q1 is also positively biased, and current flows between the collector C of transistor Q1 and the emittor E of transistor Q1. The emittor E of transistor Q1 is wired to the timer T1, which can be formed, e.g., from a TLC 555 Timer and in response to the onset of current flow can generate a precisely defined pulse that closes a relay RL2 and a switch SS1. The use of an integrated circuit such as timer T1 provides for the generation of a precisely defined valve close signal that ensures closure of a valve like a magnetic latching valve. When switch SS1 closes, an alarm 700 which can be formed of an audible 12 VDC buzzer, will sound. Alarm 700 (and/or display 810) can also be formed by one or more LED's L1 and/or L2, shown here as illuminating when the respective of relays RL1 and RL2 closes. Furthermore, when relay RL2, which can be formed of a double pole/double throw 12 VDC relay, closes, then a valve close signal is transmitted to one or more valves 70, closing the valve and halting further water transport to the moist region. This is done in conjunction with silicon controlled rectifier SCR1 and SCR2, which can be replaced by relays as needed. Furthermore, when the current flow through the transducer Q1 stops, then transmission of the valve close signal to one or more valves 70 is halted and, if needed as in the case of a magnetic latching valve, a valve open signal is transmitted to one or more valves 70.

Exemplary component descriptions are provided below in Table 1. These are provided only to further aid one of ordinary skill in the art in determining operational parameters of the components that form the invention, and do not limit the scope of the claims.

TABLE 1

| Reference | Component Description |
|---|---|
| C1 | 22 μf, 15 Capacitor |
| D1, D2 | 1N4001 Diode |
| L1 | Green LED |
| L2 | Red LED |
| R1 | 68kΩ, ¼ Watt Resistor |
| R2, R3 | 3.3kΩ, ¼ Watt Resistor |
| RL1, RL2 | S.P.D.T. 12 VDC Relay |
| SCR1, SCR2 | Silicon Controlled Rectifier |
| J1 | 7 Pin Male Jack |
| J2 | 5 Pin Screw Terminal |
| Q1 | PN 2222A NPN Transistor |
| T1 | TLC 555 Timer |

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A water leak detector system, comprising:
a valve configured to open or close a pipe upon receipt of a valve signal;
a controller configured to receive notification indicative of a water leak and to transmit said valve signal to said valve; and
a wireless moisture detector configured to determine the presence of water indicative of said water leak and transmit said notification indicative of said water leak in response to said presence, wherein
said wireless moisture detector including a transmission means for wirelessly transmitting said notification indicative of said water leak and said controller including means for wirelessly receiving said notification indicative of said water leak.

2. The water leak detector system according to claim 1, wherein said wireless moisture detector includes an ID encoder that provides said wireless moisture detector with identification information that is recognizable by said controller.

3. The water leak detector system according to claim 1, wherein said wireless moisture detector includes a battery power supply.

4. The water leak detector system according to claim 3, wherein said wireless moisture detector includes a power supply check configured to determine a voltage level of said battery power supply and provide a notification signal when said voltage level drops below a certain level.

5. The water leak detector system according to claim 1, further comprising a repeater configured to receive, amplify, and retransmit wireless communications, including said notification indicative of said water leak, said wireless communications traveling between said controller and said wireless moisture detector.

6. The water leak detector system according to claim 1, wherein said controller includes a network connection configured to transmit water leak detector system status information and to receive water leak detector system commands.

7. The water leak detector system according to claim 1, wherein said valve comprises a magnetic latching valve.

8. The water leak detector system according to claim 1, wherein said transmission means comprises an RF antenna.

9. The water leak detector system according to claim 1, further comprising a battery power supply.

10. The water leak detector system according to claim 1, wherein said controller further comprises an integrated circuit timer configured to generate a valve close signal.

11. A method for detecting and suppressing a water leak, comprising:
transducing the presence of water in the neighborhood of a wireless sensor;
transmitting wirelessly a moisture detection signal from said wireless sensor indicative of said presence of water; and
closing a valve in response to receipt of said moisture detection signal.

12. The method according to claim 11, further comprising:
denoting said wireless sensor by identifying information; and
transmitting wirelessly said identifying information along with said moisture detection signal.

13. The method according to claim 12, further comprising:
receiving said identifying information; and
localizing said wireless sensor using said received identifying information.

14. The method according to claim 11, further comprising:
supplying said wireless sensor with power using a battery.

15. The method according to claim 14, further comprising:
monitoring a power level of said battery.

16. The method according to claim 15, further comprising:
transmitting wirelessly a low power level signal along with said moisture detection signal when said power level of said battery drops below a predetermined power level.

17. The method according to claim 15, further comprising:
signalling audibly from said wireless sensor when said power level of said battery drops below a predetermined power level.

18. The method according to claim 11, further comprising:
receiving wirelessly said moisture detection signal;
amplifying said moisture detection signal; and
repeating wirelessly said amplified moisture detection signal.

19. The method according to claim 11, further comprising transmitting status information and receiving water leak detector system commands by way of a communications network.

20. The method according to claim 11, wherein said closing a valve step comprises sending a pulse to a magnetic latching valve.
